(19) United States
(12) Patent Application Publication
(10) Pub. No.: US 2020/0089082 A1
(43) Pub. Date: Mar. 19, 2020

(54) PEEL-OFF CAMERA LENS COVER FOR PORTABLE ELECTRONIC DEVICES AND TELEVISIONS

(71) Applicant: NSSI IVS, Horsens (DK)

(72) Inventor: Nicolai Stokholm Sondrup-Ottsen, Horsens (DK)

(21) Appl. No.: 16/618,692

(22) PCT Filed: May 28, 2018
(86) PCT No.: PCT/EP2018/063916

§ 371 Date: Dec. 2, 2019

(30) Foreign Application Priority Data
Jun. 2, 2017 (DK) PA 2017 00333

(51) Int. Cl. G03B 11/04; G03B 17/56

(52) U.S. Cl. CPC G03B 11/048; G03B 17/568

(57) ABSTRACT

The present invention relates to a peel-off camera lens cover for portable electronic devices and televisions, comprising a flexible material sheet having a back face and a front face. The back face comprises a first, second, and third area. The first area covers the center area of the back face, and the second and third areas cover the side edges of the back face. The second area is coated with a peelable adhesive coating, and the first and third areas are substantially free from said peelable adhesive coating.

### TECHNICAL FIELD OF THE INVENTION

The present invention relates to devices and systems for privacy protection in relation to the camera lens of portable electronic devices and televisions.

### BACKGROUND OF THE INVENTION

Mobile devices, particularly smartphones and tablets, can be activated in one's pocket, purse or briefcase and, generally, at inopportune moments. Many laptop computers have a small camera lens integrated into the frame of the display. The camera lens may then be easily used by the user to take a picture of himself or herself, or to transmit still or video images while sitting in front of the computer. The ease of use of such a camera lens can be problematic. A user may not realize that the camera is on and may inadvertently step photographs or transmit still or video images over a network to another location without realizing it. Technology also exists where an individual or entity can remotely and without a user's authorization activate a user's mobile device or laptop computer and utilize the camera.

### SUMMARY OF THE INVENTION

It is an object of the present invention to provide a device and system for privacy protection in relation to the camera lens of portable electronic devices and televisions.

A first aspect relates to a peel-off camera lens cover for portable electronic devices and televisions, comprising a flexible material sheet having a back face and a front face; wherein the back face comprises a first, second, and third area; wherein the first area covers the center area of the back face, and wherein the second and third areas cover the side edges of the back face; wherein the second area is coated with a non-destructive peelable adhesive coating, and wherein the first and third areas are substantially free, preferably completely free, from said non-destructive peelable adhesive coating.

The adhesive coating applied on the back face of the flexible material sheet may be chosen from a variety of adhesives, known in the art. When the adhesive is of high strength or a permanent nature, peeling the flexible material sheet off the surface on which it is applied usually results in some damage to the surface on which it is applied. On the other hand, when the adhesive coating is of a weak, non-destructive or temporary adhesion nature, as the flexible material sheet is peeled off, the adhesive remains on the back face of the flexible material sheet and the application surface suffers no damage.

The third area serves as a grasp strip for use in the peel-off operation.

A second aspect relates to a peel-off camera lens cover for portable electronic devices and televisions, comprising a flexible material sheet having a back face and a front face; wherein the back face comprises a first, second, and third area; wherein the first area covers the center area of the back face, and wherein the second and third areas cover the side edges of the back face; wherein the second area is coated with a peelable adhesive coating, and wherein the first and third areas are substantially free, preferably completely free, from said peelable adhesive coating.

As used herein, the term “portable electronic device” may include any type of wireless communication devices, such as, e.g., mobile telephone, tablet, portable computer, gaming device, media player, smartphone, personal organizer, and the like.

In one or more embodiments, the flexible material sheet further comprises a cut-out extending from the back face and to the front face, and wherein the cut-out is positioned within the first area. As used herein, the term “cut-out” refers to a hole, slit, or other void in the flexible material sheet. This configuration allows for units (such as proximity sensors, loudspeakers, and the like) in close relation to camera lens to continue to function.

In one or more embodiments, the cut-out is of a size suitable for delimiting a loudspeaker and/or a proximity sensor of a portable device.

In one or more embodiments, at least a part of the peel-off camera lens cover corresponding to the first area, is blurred or coloured, preferably dark colours, such as black. More specifically the part that is configured to cover the camera lens.

In one or more embodiments, at least a part of the peel-off camera lens cover corresponding to the first area, is opaque. More specifically the part that is configured to cover the camera lens.

In one or more embodiments, the second area completely delimits the first area. To reduce the risk that the peel-off camera lens cover is accidentally peeled off when e.g. a mobile phone is positioned in a user's pocket, the third area may just cover a single corner of the back face.

In one or more embodiments, a third area is bordering the first area, and at the same time being delimited by a second area. This configuration reduces the risk that the peel-off camera lens cover is accidentally peeled off when e.g. a mobile phone is positioned in a user's pocket.

In one or more embodiments, a third area runs from corner to corner along the length of the flexible material sheet.

A second aspect relates to a plurality of peel-off camera lens covers according to the present invention, wherein the peel-off camera lens covers are disposed one on top of another such that a back face of a first peel-off camera lens cover is adhered to a front face of a second peel-off camera lens cover, and wherein the adherence is provided by the peelable adhesive coating on the second area of said back face.

The plurality of peel-off camera lens covers may be provided in a dispenser that can be adhered to the back face of a mobile phone, or the dispenser may be configured as an integrated part of a mobile phone cover.

Another aspect relates to the use of a peel-off camera lens cover according to the present invention for covering the camera lens of portable electronic devices and televisions.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a first group of peel-off camera lens covers in accordance with various embodiments of the invention;

FIG. 2 shows a second group of peel-off camera lens covers in accordance with various embodiments of the invention;

FIG. 3 shows a first peel-off camera lens cover in accordance with various embodiments of the invention, positioned in the front of a mobile phone;

FIG. 4 shows a second peel-off camera lens cover in accordance with various embodiments of the invention, positioned on the front of a mobile phone;

FIG. 5 shows a third group of peel-off camera lens covers in accordance with various embodiments of the invention; and

FIG. 6 shows a third peel-off camera lens cover in accordance with various embodiments of the invention, positioned on the front of a mobile phone.

### DETAILED DESCRIPTION OF THE INVENTION

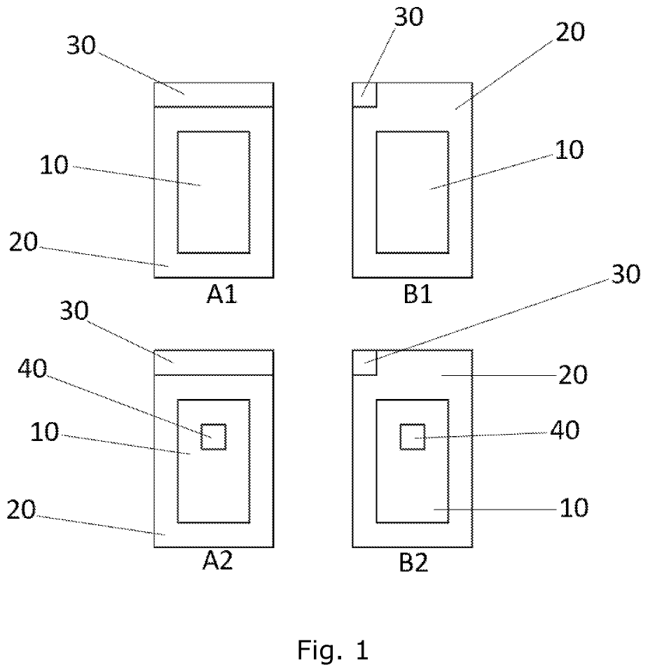

FIG. 1 shows a first group of peel-off camera lens covers in accordance with various embodiments of the invention. The peel-off camera lens covers each comprises a flexible material sheet having a back face and a front face. The back face comprises a first 10, second 20, and third 30 area. The first area 10 covers the center area of the back face, and the second 20 and third 30 areas cover the side edges of the back face. The second area 20 is coated with a non-destructive peelable adhesive coating, and the first 10 and third 30 areas are substantially free from said non-destructive peelable adhesive coating. The common denominator of the first group of peel-off camera lens covers is that the second area 20 completely delimits the first area 10. The peel-off camera lens cover Al has a third area 30 that spans the back face from one corner to another. In this way, a part of the flexible material sheet corresponding to the third area 30 is left unadhered to the surface onto which it is applied. This part serves as a grasp strip for use in the peel-off operation. To reduce the risk that the peel-off camera lens cover is accidentally peeled off when e.g. a mobile phone is positioned in a user's pocket, the third area may just cover a single corner of the back face as seen in B1.

The flexible material sheet may further comprise a cut-out 40 extending from the back face and to the front face, and wherein the cut-out 40 is positioned within the first area 10 (A2, and B2). This configuration allows for units in close relation to camera lens to continue to function, such as proximity sensors, loudspeakers, and the like.

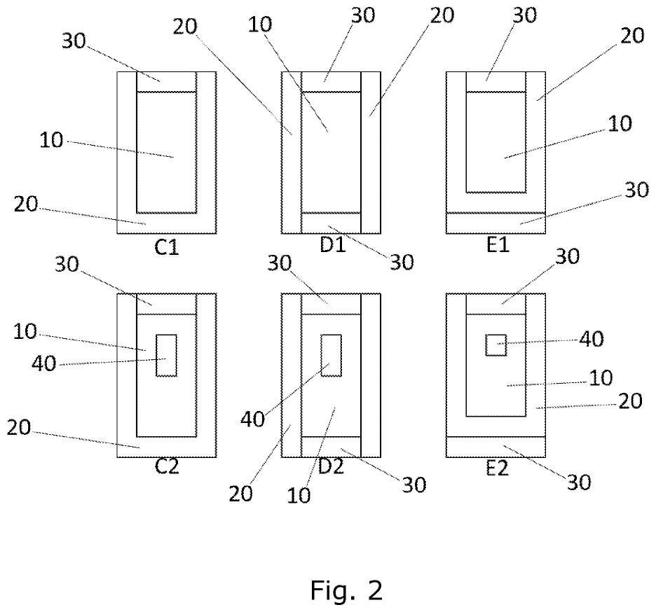

FIG. 2 shows a second group of peel-off camera lens covers in accordance with various embodiments of the invention. The common denominator of the second group of peel-off camera lens covers is that a third area 30 is bordering the first area 10, and at the same time delimited by the second area 20. This configuration reduces the risk that the peel-off camera lens cover is accidentally peeled off when e.g. a mobile phone is positioned in a user's pocket. C1 has only one third area 30, while D1 has two third areas. C2 and D2 has a cut-out 40 is positioned within the first area 10. E1 is a hybrid of A1 and C1, while E2 is the cut-out version.

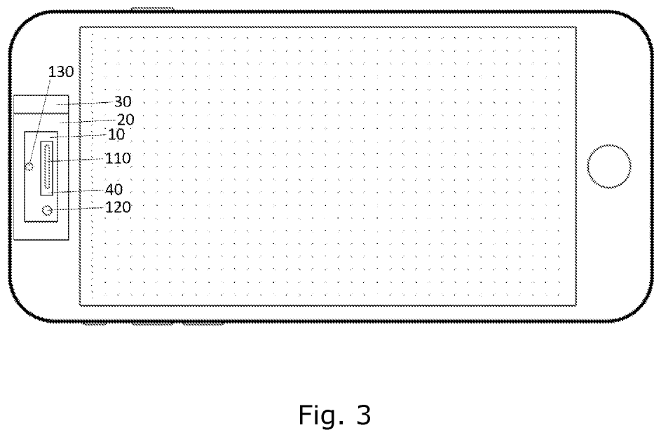

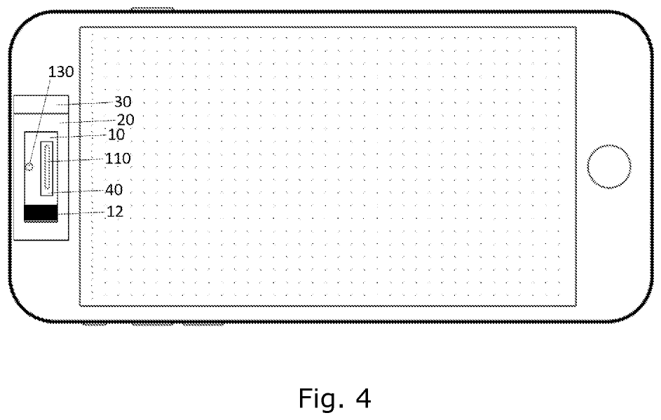

FIG. 3 shows an A2 version of a peel-off camera lens cover, positioned on the front of a mobile phone. The A2 version of a peel-off camera lens cover is shown transparent to show the camera lens in relation thereto. However, at least a part of the peel-off camera lens cover corresponding to the first area 10, will be blurred or coloured, more specifically the part that covers the camera lens, as shown in FIG. 4. The part covering the proximity sensor 130 is transparent. A cut-out could also secure that the proximity sensor remains operative. A cut-out 40 extends from the back face and to the front face, and is positioned within the first area. The cut-out 40 is of a size suitable for delimiting a loudspeaker 110 of the mobile phone.

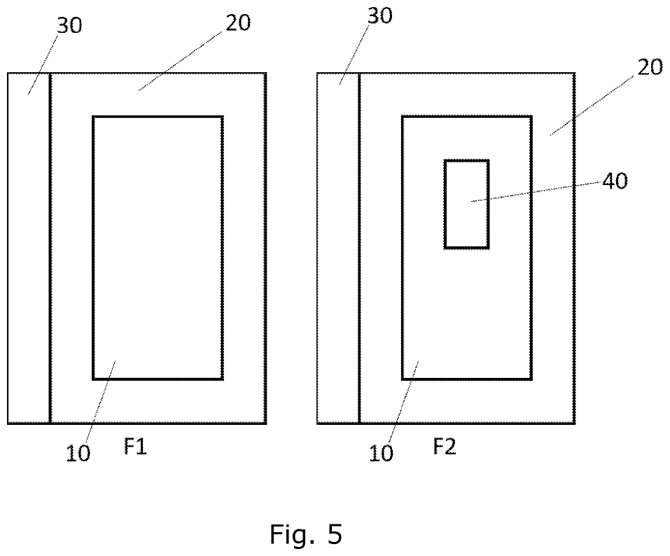

FIG. 5 shows a third group of peel-off camera lens covers in accordance with various embodiments of the invention. The common denominator of the third group of peel-off camera lens covers (F1 and F2) is that a third area 30 runs from corner to corner along the length of the flexible material sheet.

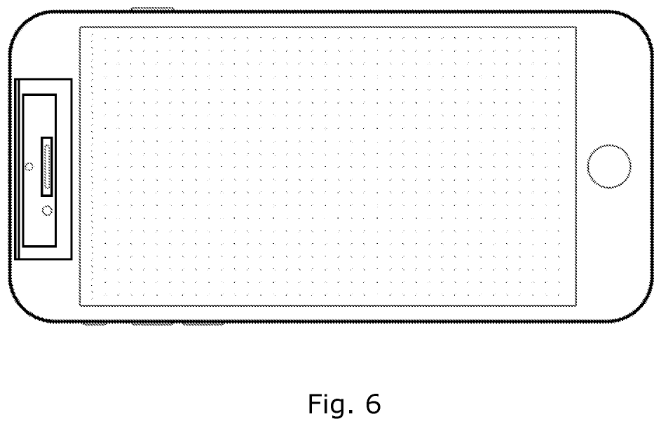

FIG. 6 shows an F2 version of a peel-off camera lens cover, positioned on the front of a mobile phone.

### REFERENCES

10 First area

12 Blurred or coloured part of the first area

20 Second area

30 Third area

40 Cut-out

110 Loudspeaker

120 Camera lens

130 Proximity sensor

1. A peel-off camera lens cover for portable electronic devices and televisions, comprising
a flexible material sheet having a back face and a front face;
wherein the back face comprises a first area, second area, and third area;
wherein the first area covers the center area of the back face, and wherein the second and third areas cover the side edges of the back face;
wherein the second area is coated with a peelable adhesive coating, and wherein the first and third areas are substantially free from said peelable adhesive coating; and
wherein at least a part of the peel-off camera lens cover corresponding to the first area is blurred, opaque, or coloured.

2. A peel-off camera lens cover according to claim 1, wherein the flexible material sheet further comprises a cut-out extending from the back face and to the front face, and wherein the cut-out is positioned within the first area wherein the cut-out (40) is of a size, such as 2-6 mm², suitable for declining a loudspeaker (110) positioned close to the camera lens on the portable device.

3. (canceled)

4. A peel-off camera lens cover according to claim 1, wherein the second area completely delimits the first area.

5. A peel-off camera lens cover according to claim 1, wherein the third area is bordering the first area, and at the same time being delimited by the second area.

6. A peel-off camera lens cover according to claim 1, wherein a third area runs from corner to corner along the length of the flexible material sheet.

7. (canceled)

8. A plurality of peel-off camera lens covers according to claim 1, wherein the peel-off camera lens covers are disposed one on top of another such that a back face of a first peel-off camera lens cover is adhered to a front face of a second peel-off camera lens cover, and wherein the adherence is provided by the peelable adhesive coating on the second area of said back face.

9-11. (canceled)

12. A method for temporarily covering a camera lens of a camera of a portable electronic device or television while a user does not use the camera of the device, the method comprising:
a) providing a peel-off camera lens cover, wherein said peel-off camera lens cover comprises a flexible material sheet having a hack lace and a front face;
wherein the back face comprises a first area, second area, and third area:
wherein the first area covers a center area of the back face, and wherein the second and third areas cover side edges of the back face;
wherein the second area is coated with a peelable adhesive coating, and wherein the first and third areas are free from said peelable adhesive coating:
wherein at least a part of the peel-off camera lens cover corresponding to the first area, is blurred or coloured;
b) positioning said peel-off camera lens cover in front of the camera ions of the portable electronic device or television, while the user does not use the camera of the device such that the first area is placed in front of the camera lens, while the second area is fastened to an area of the portable electronic devices or television delimiting the camera lens;
c) removing the peel-off camera lens cover when needing to use the camera lens of the portable electronic device or television; and
d) repeating steps a)-c) one or more times.

13. The method according to claim 12, wherein the method is performed on the portable electronic device that comprises a tablet, a portable computer, a gaming device, or a smartphone.

14. The method according to claim 12, wherein step a) comprises removing the peel-off camera lens cover from a plurality of identical peel-off camera lens covers, wherein the peel-off camera lens covers are disposed one on top of another such that a back face of a first peel-off camera lens cover is adhered to a front face of a second peel-off camera lens cover, and wherein the adherence is provided by the peelable adhesive coating on the second area of said back face.
